(19) United States
(12) Patent Application Publication
(10) Pub. No.: US 2013/0333014 A1
(43) Pub. Date: Dec. 12, 2013

(54) Open Platform for Mobile Collaboration

(71) Applicant: Adnan Batara, Jakarta Selatan (IN)

(72) Inventor: Adnan Batara, Jakarta Selatan (IN)

(73) Assignee: RADMOND GLOBAL HOLDINGS, KFT, Budapest (HU)

(21) Appl. No.: 13/979,968

(22) PCT Filed: Jan. 17, 2012
(86) PCT No.: PCT/EP2012/050617

§ 371 Date: Aug. 14, 2013

Related U.S. Application Data
(60) Provisional application No. 61/433,621, filed on Jan. 18, 2011.

(51) Int. Cl. H04L 29/06

(52) U.S. Cl. CPC H04L 63/083
USPC 726/7

(57) ABSTRACT

A platform is provided which facilitates collaboration among a plurality of users on a project (such as the exploration for oil or natural gas on an oil rig), data set and/or data stream. The platform (301) comprises (a) a data hub (315) configured to allow a plurality of users to store data on the data hub and to retrieve data from the data hub; (b) an interface (319) associated with the data hub which is independently configurable by each of said plurality of users, wherein each user has a set of user preferences associated with that user which controls the configuration of the interface when it is accessed by that user; (c) a plurality of data files stored on said hub, wherein each of said data files is associated with one of said plurality of users and is accessible via the interface; (d) a security system (331) which authenticates a user and which restricts access of the data files to those data files associated with the user; and (e) functionality allowing a user to manipulate data in the hub, including by use of external software loaded onto the hub.

### CROSS-REFERENCE TO RELATED APPLICATIONS

This application is a 371 of international patent application number PCT/EP2012/050617 filed Jan. 17, 2012, having the same inventor and the same title, and which is incorporated herein by reference in its entirety, which application claims the benefit of U.S. provisional application No. 61/433,621, filed Jan. 18, 2011, having the same inventor and the same title, and which is incorporated herein by reference in its entirety.

### FIELD OF THE DISCLOSURE

The present disclosure relates generally to communications platforms, and more particularly to systems and methods for collaboration over open platforms.

### BACKGROUND OF THE DISCLOSURE

Various commercial endeavors require the collaboration of diverse parties with diverse skill sets to bring the endeavor to fruition. Frequently, it is necessary for these parties to exchange data, to obtain access to data generated as part of the endeavor, or to manipulate the data in order to create useful information. These tasks are frequently complicated by the fact that the parties collaborating on the project may be working from geographically disperse locations, and are often business competitors of each other.

For example, in the operation of an oil rig during oil or natural gas exploration, a variety of data is generated concerning the condition or status of the well, rig, drilling equipment, drilling operations, and various supplies and resources. This data will typically be generated by the party responsible for a particular task. Data will also be created in the form of alerts generated by monitoring equipment, which are issued from time to time to notify interested parties of potential problems with the well, the rig or the drilling equipment. All of this data must be processed into information so that appropriate action may be taken at each point in time by the appropriate parties, and the information so generated must typically be monitored by the exploration company.

### BRIEF DESCRIPTION OF THE DRAWINGS

FIG. 1 is an illustration of a system architecture over which the systems and methodologies described herein may be implemented.

FIG. 2 is an illustration of a first embodiment of a system in accordance with the teachings herein.

FIG. 3 is an illustration of a second embodiment of a system in accordance with the teachings herein.

FIG. 4 is an illustration of the functionality of one particular, non-limiting embodiment of a system in accordance with the teachings herein.

### SUMMARY OF THE DISCLOSURE

In one aspect, a platform is provided which facilitates collaboration among a plurality of users on a project (such as the exploration for oil or natural gas on an oil rig), data set and/or data stream. The platform comprises (a) a data hub configured to allow a plurality of users to store data on the data hub and to retrieve data from the data hub; (b) an interface associated with the data hub which is independently configurable by each of said plurality of users, wherein each user has a set of user preferences associated with that user which controls the configuration of the interface when it is accessed by that user; (c) a plurality of data files stored on said hub, wherein each of said data files is associated with one of said plurality of users and is accessible via the interface; and (d) a security system which authenticates a user and which restricts access of the data files to those data files associated with the user.

In another aspect, a method is provided for obtaining services from third parties. The method comprises (a) providing a platform (preferably of the type described above) associated with a company and upon which third party service providers can register to receive notices of service requests; (b) posting service requests to the platform, wherein each service request contains a description of the service required; and (c) receiving bids from the third party service providers in response to the posted service requests.

In a further aspect, a method is provided for facilitating collaboration among parties working on a project, data set, and/or data stream, wherein the collaboration involves the generation or manipulation of data by one or more of the parties. The method comprises (a) providing a platform of the type described above; (b) storing the data on the data hub in a plurality of data files; (c) associating a particular data file with a particular set of users; (d) restricting access to each of the plurality of data files to those users associated with the data file; and (e) allowing a user to manipulate data in the hub, including, but not limited to, by the use of external software loaded onto the hub.

In still another aspect, a method is provided by which an entity can offer goods or services to other parties. The method comprises (a) providing a platform associated with the entity and upon which parties can register to post requests for goods or services from the entity; (b) receiving the requests at the platform, wherein each request contains a description of the goods or services required; and (c) posting bids to the platform from the entity in response to the posted requests.

In yet another aspect, a non-transitory computer readable medium is provided which contains programming instructions, the execution of which, by one or more processors of a computer system, causes the one or more processors to carry out the foregoing methods or to establish the foregoing systems.

### DETAILED DESCRIPTION

A variety of solutions have emerged in the marketplace to deal with the enormous amount of data and information generated during oil and natural gas exploration and other such collaborative endeavors. However, the real time operations (RTO) solutions which have been developed to date suffer from a number of infirmities which adversely affect the ability of parties to collaborate on the underlying project.

At present, RTO solutions are typically implemented as proprietary systems. Thus, most RTO systems in the oil and gas industry are derived from the down-hole data acquisition systems associated with the service company, where proprietary information of their latest technology is utilized. Each service company has its own implementation methods. Recent advances in hardware and software designs allow independent RTO service providers to build their own systems. However, by design, these systems function as a data aggregation service only, and do not provide software as a service (SaaS).

Conventional RTO solutions are also typically configured to provide only passive participation from data sources. In order to protect the proprietary technology implemented by the solution, conventional RTO systems do not allow other parties to control and configure the system. Hence, these systems expect data sources to stream data using industry standard protocols such as WITS and/or WITSML based on predefined or agreed sequences or lists. If there is a new requirement or a change in data type, both parties to a data exchange must typically repeat the cycle in order to ensure that the data being sent and received matches. The major drawback in this scenario is that the data source cannot directly participate to perform in-system data quality control (QC) or to create event/incident entries. Moreover, at present, event recording is typically part of a 12-hour batch reporting practice, which is already after-the-fact instead of real time.

Conventional RTO solutions also typically require a specialist to run the system. In particular, the system must be operated either by the system vendor, by trained customer IT personnel, or by an engineer associated with a 3rd party reseller.

In addition, conventional RTO solutions suffer from an unstructured or oversimplified data ownership structure. In particular, while current RTO systems have proper system authentication and authorization to own and access the data, the security is provided only at the system level. Hence, there is no data level security protection built in.

Finally, current solutions suffer from manual and rigid data control processing. In particular, data integrity checks must be performed manually by an RTO engineer who is typically the system administrator. This situation arises in part from the lack of a clear data ownership structure implemented in the system.

It has now been found that some or all of the foregoing needs may be addressed by the systems and methodologies disclosed herein. These systems and methodologies may be utilized to create an open platform for mobile collaboration which is preferably powered by open source software, and which is preferably enabled by Web 2.0 solutions. This platform may be used to establish a secure solutions marketplace (SSM) along with a real time virtual work space (RVWS). The SSM is secure in that it preferably follows industry standard best practices in protecting data confidentiality and integrity. Typically, this is accomplished through the proper use of authentication to access the system interface, and by requiring that a party have appropriate authorization to access data and system resources.

The systems and methodologies disclosed herein may cover all products and their associated value-added services which are utilized to transform data into information for decision making purposes. These systems and methodologies may include data visualization, data mining, data processing, data interpretation, and data transformation. In a preferred embodiment, the platforms described herein will be openly configurable and accessible to all parties involved with a collaborative endeavor. Thus, for example, in the case of oil and natural gas exploration, the platform may be openly configurable and accessible to oil and natural gas companies or operators, rig companies or drilling contractors, service companies, independent consultants or subject matter experts, and regulatory bodies (including local governments).

For purposes of illustration, the systems and methodologies described herein will frequently be illustrated and explained with respect to their implementation in the oil and natural gas exploration field, since many embodiments of these systems and methodologies are particularly advantageous in facilitating the collaboration required from diverse parties in this field. It will be appreciated, however, that these systems and methodologies are broadly applicable in a variety of fields, especially in applications requiring extensive collaboration between parties, and hence are not limited to the field of oil and gas exploration.

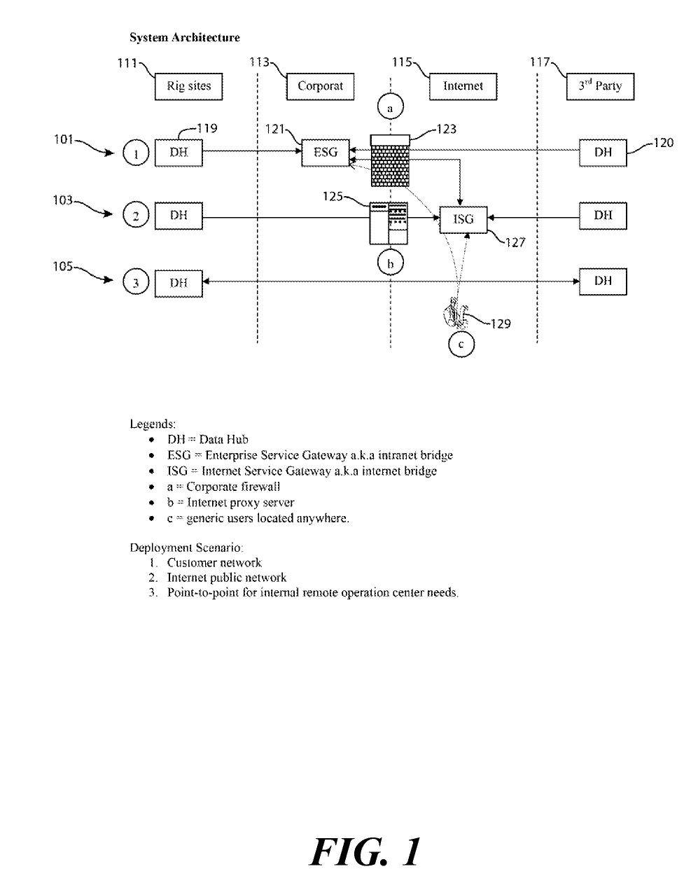

FIG. 1 depicts first 101, second 103 and third 105 particular, non-limiting embodiments of system architectures over which the systems and methodologies disclosed herein may be implemented. For purposes of illustration, these embodiments are described specifically with respect to their implementation in oil and natural gas exploration. However, it will be appreciated that each of these embodiments is applicable to any type of collaborative effort utilizing the disclosed communications infrastructures. In each of these architectures, a data hub 119 is maintained at a first location (a rig site 111) and is replicated at a second location (a third party site 117), but the network 112 over which communications occur is different in each instance.

In the first embodiment 101, the customer 113 (typically an oil and natural gas exploration company) has its own network, and communications between the customer 113 and the rig site 111 (and its associated data hub 119) occur via an enterprise service gateway (ESG) 121 (also known as an intranet bridge). The ESG 121 in this embodiment will typically reside behind a corporate firewall 123. If a contractor or other third party 117 is required to obtain access to data, they do so through the Internet 115 or (other public communications network) and the company's firewall 123 to connect to the ESG 121.

In the second embodiment, the customer 113 maintains a site on a public communications network such as the Internet 115, and communications between the customer 113 and the rig 111 occur via an Internet Service Gateway (ISG) 127 (also known as an Internet Bridge). The ISG 127 in this embodiment will typically be associated with an Internet proxy server 125, and the customer 113 provides Internet connectivity for third parties 117 to send data to the ISG 127 from the third party's data hub 120.

In the third embodiment 105, the customer does not maintain a network independent of the data hub 119 on the rig 111. In this embodiment, communications occur in a point-to-point manner between the data hub 119 on the rig 111, a data hub 120 associated with a third party 117, and the associated users at 129 who may be working from various locations. Hence, in this embodiment, a contractor or other third party 117 may have employees on the rig 111 collecting data, and if they wish to send data from the rig 111 to another site, they will have to use the data hub 119 on the rig 111 and a third party data hub 120 (which may be their own data hub or the data hub of another third party) to establish an ad hoc point-to-point connection. Hence, the data in the data hub 119 at the rig site will be exactly the same as the data in the data hub 120 at the corporate office of the customer. In other words, the data from the data hub 119 at the rig site is simply replicated at the customer's data hub 120.

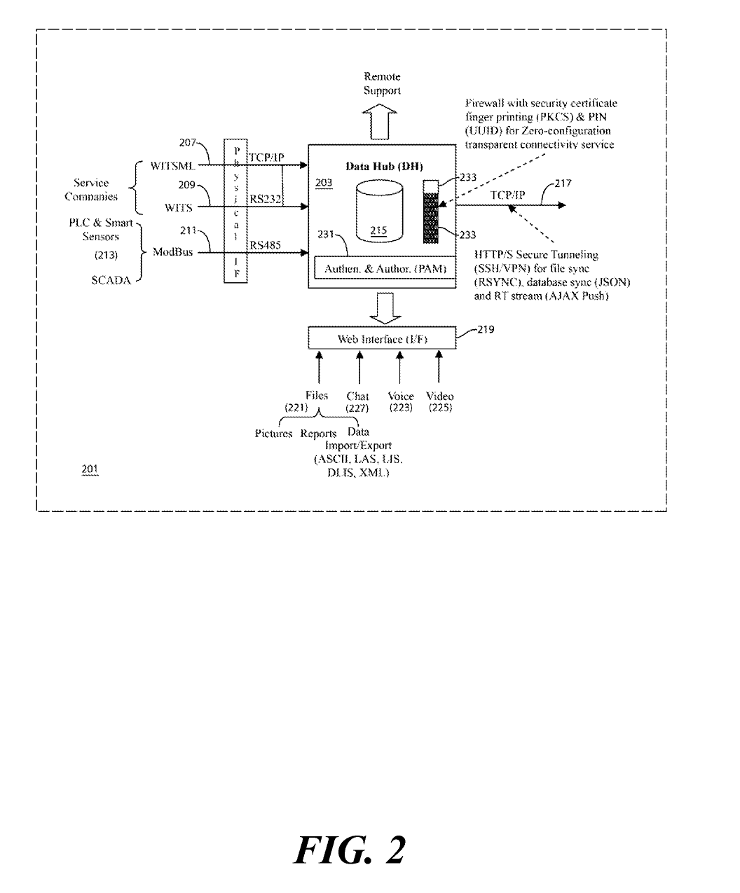

FIG. 2 illustrates a particular, non-limiting embodiment of a platform which may be utilized to implement some of the methodologies disclosed herein. In the embodiment of FIG. 2, the platform 201 comprises a data hub 203 which acts as a data logger, and which is equipped with a data interface 205. The data interface 205 in this particular embodiment is equipped with a variety of connections, including a TCP/IP connection 207, an RS232 serial cable 209, and an RS485 cable 211 (a serial cable with a special connection for connecting the data hub to a control system). All three of these connections implement standard industry protocols, and most modern computer equipment has interfaces for all three.

The data hub 203 is adapted to collect data from service companies at the rig site using common data transfer protocols. Many service companies will use the WITSML (Wellsite Information Transfer Standard Markup Language) protocol or the older WITS (Wellsite Information Transfer Specification) protocol for data exchange.

The data hub 203 also collects data from PLCs (programmable logic controllers, which are digital computers used for automation of electromechanical processes) and smart sensors 213. A protocol known as ModBus, which is a serial communications protocol for PLCs, may be utilized for this purpose. ModBus allows for communication between many devices connected to the same network. By way of example, ModBus may be utilized by a system that measures temperature and humidity to communicate the results to a computer. The rig site automation control system is typically controlled by a PLC system which communicates with a control center via a MODBUS protocol.

ModBus is also preferably used in the platform 201 as the protocol for communications between supervisory computers and remote terminal units (RTUs) in SCADA (Supervisory Control and Data Acquisition) systems 214 associated with the platform 201. While protocols such as WITSML are commonly used for the exchange of information between a control center and a rig, SCADA protocols are the current industry standard used in oil and gas rigs for monitoring and control systems. Hence, SCADA systems typically collect data and send it to a remote control center, and receive commands from the control center which allow the control center to control system components such as valves and pumps. Thus, by way of example, SCADA systems allow a control center to monitor how much oil and gas is being produced at a rig, and to increase or decrease production by sending appropriate control signals. In contrast to SCADA, which is utilized in systems having both monitoring and control functionalities, WITSML and WITS are purely information exchange protocols (i.e., they provide only a monitoring functionality).

In a typical implementation, the SCADA system 214 may consist of the following subsystems:
(a) A Human-Machine Interface (HMI). This is the apparatus which presents process data to a human operator, and through which the human operator monitors and controls a process.
(b) A supervisory (computer) system, which gathers or acquires data on the process and sends commands or controls to the process.
(c) Remote Terminal Units (RTUs). These units connect to sensors in the process, convert sensor signals to digital data, and send the digital data to the supervisory system.
(d) PLCs. These devices are used as field devices because they are more economical, versatile, flexible, and configurable than special-purpose RTUs.
(e) Communication infrastructure which connects the supervisory system to the RTUs.

The data being generated at the rig site is received and aggregated by the data hub 203 into a database 215. Depending on the system architecture (see FIG. 1), a TCP/IP connection 217 connects the data hub 203 to either a service gateway (121 in FIG. 1) or to a second data hub (120 in FIG. 1) to replicate the data that has been collected by the data hub 203. The TCP/IP connection 217 preferably utilizes secure tunneling (which may be implemented as secure shell (SSH) tunneling or a virtual private network (VPN)) for file synchronization, database synchronization and real-time (RT) streaming. Such secure tunneling may be implemented with the Hypertext Transfer Protocol (HTTP) or Hypertext Transfer Protocol Secure (HTTPS), the latter of which is a combination of HTTP with the secure sockets layer/transport layer security (SSL/TLS) protocol.

Database synchronization is preferably implemented using JavaScript object notation (JSON), a lightweight text-based open standard designed for human-readable data interchange. RT streaming is preferably implemented using asynchronous JavaScript and XML push (AJAX Push), a web application model in which a long-held HTTP request allows a web server to push data to a browser without the browser explicitly requesting it.

The TCP/IP connection 217 to the data hub 203 is preferably secured with a firewall 233. The firewall 233 is preferably equipped with security certificate finger printing, which preferably utilizes public-key cryptography standards (PKCS) and personal identification numbers (PINs) or other universally unique identifiers (UUIDs) for zero-configuration transparent connectivity service.

Conventional systems for exchanging data between a rig and a control center have an input and an output, and replicate data from the rig site to the control center. By contrast, in the system depicted in FIG. 2, the data hub 203 is equipped with a full web interface 219 so that any party will be able to operate the data hub 203 and will be able to control and configure the web interface 219. This web interface 219 provides for the exchange of files 221, such as pictures and reports, and further provides for the import or export of data in various file formats, such as ASCII (American Standard Code for Information Interchange), LAS (Log ASCII Standard), LIS (Log Information Standard), DLIS (Digital Log Interchange Standard) and XML (Extensible Markup Language) formats. Voice 223, video 225 and chat 227 functionalities are also preferably supported.

As a result of the web interface 219, the data hub 203 operates like an independent, stand-alone server which allows any interested party to connect to and access it with web browser software. Consequently, there is no need to download any software—rather, a party only needs to input the web address to gain access to the data hub 203. After that, the party can configure the data hub 203 with personalized settings as the party sees fit, and the configuration does not require any kind of specialized knowledge (an analogy may be made here to a user's homepage on the FACEBOOK™ social network, in that the homepage does not require that the user have any kind of specialized knowledge in order to use or configure it).

The advantages of the system of FIG. 2 may be more fully appreciated by considering conventional systems used in the oil and gas industry to collect data at a rig. In such systems, the data hub is typically proprietary, and can only be configured by the service provider that is providing the database. Hence, when service companies are providing services at a rig, an expert is typically required to configure the data hub. By contrast, a system of the type depicted in FIG. 2 reduces operating costs by eliminating the need for such an expert.

Moreover, in a typical exploration operation in the oil and gas industry, the operator has to employ service companies in order to drill a well. In particular, the operator typically does not own the drilling rig, but contracts a drilling company to drill the well. During drilling operations, there may be 10 to 15 different service companies operating on the rig, some of which may be in competition with each other. Typically, all of the service companies are generating data of one type or another, and all of the data needs to be available to the operator for monitoring purposes.

Also, in a conventional operation, the communications platform containing the data hub will be owned and operated by one of the service companies, and hence, that company will have to allow the other service companies—some of whom are their competitors—to have access to the data hub. However, service companies are typically reluctant to allow their competitors (the other service companies) to configure their data hubs. Hence, the service company will typically have an engineer available to maintain the data hub, get the data stream from all of the service companies, and send it to the operator so that the operator can monitor the data.

By contrast, the system depicted in FIG. 2 provides an open web interface 219 so that each service company can configure its own data without the need to involve an expert. In particular, the open web interface 219 allows each service company to configure the web interface 219. However, the data entered into the data hub 203 will ultimately be input in the same format. Each service provider is thus able to establish its own access to its own data, and is able to configure the web interface 219 as it sees fit. Moreover, access to the data of a service provider may be secured with a user ID and password by way of an authentication and authorization system 231, which may utilize pluggable authentication modules (PAM).

A further advantage of the system of FIG. 2 over conventional systems in the art relates to data security. Conventional communications platforms utilized in the art are equipped with system-based data security. Hence, once a party has access to the system, that party can see all of the data. In such a system, the service companies do not have access to the data hub, and the data hub is proprietary to a particular company. By contrast, in the system of FIG. 2, all parties of interest will have access to the data hub 203. However, in order to prevent these parties from being able to see each other's data, security may be provided at both the system level and the data level. Therefore, while all of the parties of interest will have access to the data hub 203, they will not be able to see each other's data within the data hub 203.

A further issue faced with conventional systems in the art relates to the operation of software on the data in the data hub. Typically, the data coming into the data hub is useful only after it is processed into information, and hence, a data hub requires applications to process the data contained in the data hub. For example, graphics software may be utilized to visualize the data, and data mining software may be utilized, for example, to perform statistical analyses on the data. It may also be necessary to perform data processing on the data to remove errors or anomalies from the data, to interpret the data, or to perform other such functions. Since data hubs in conventional systems are typically proprietary, the software which processes the incoming data is also a proprietary. This often limits the customer/operator to using specific service providers. Moreover, the data hub itself is typically capable of running few, if any, applications, due to processing power limitations.

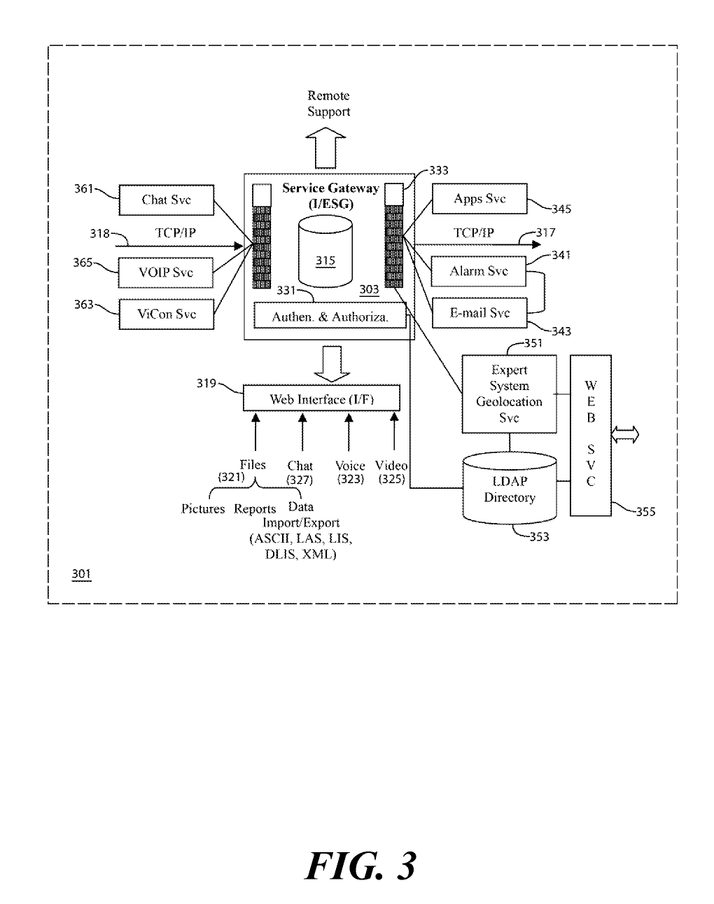

FIG. 3 depicts a second particular, non-limiting embodiment of a platform in accordance with the teachings herein. The platform 301 of FIG. 3 overcomes the foregoing infirmity through the provision of a service gateway 334 which is adapted to run the applications used to process data resident in a data hub 315.

In the system of FIG. 3, the data hub 315 collects all of the incoming data. The data hub 315 further provides access to a particular service party to the data input by that service party, thus allowing the service party to configure its data stream. The system 301 provides security at the data level, so that the data corresponding to each service party is not accessible to any other party without permission. Hence, the data hub 315 collects the data and configures it correctly, and the security is built in.

As with the previous embodiment, the embodiment of FIG. 3 is equipped with an open web interface 319 which is configurable by each service company, which allows each service company to configure its own data without the need to involve an expert, which allows each service company to establish its own access to its own data, and which provides voice 323, video 325 and chat 327 functionalities and for the exchange of files 321 as described with respect to the previous embodiment. Also as with the previous embodiment, the embodiment of FIG. 3 is equipped with an authentication and authorization system 331 which may utilize pluggable authentication modules (PAM) and which allows access to the data of a service provider to be secured with a user ID and password.

The system 301 of FIG. 3 is provided with a TCP/IP connection 317, and the data hub 315 is accessible either through an ESG (within the corporate security firewall) or an ISG (over the Internet). The data hub 315 collects data and replicates it into the service gateway 334.

One usage for the data hubs described herein relates to the processing of alerts. Currently, some oil companies utilize a so-called real time center (RTC) to monitor the mud level in several different oil wells. The mud pit level may change for several different reasons. Typically, this will trigger an alert, and the person in the RTC (in town) will call the rig crew to find out why the mud pit level changed. If there is a reason for the mud pit level change, an explanation will be provided by someone at the rig, and the alert will be closed. Alerts are classified is red, yellow and green. If a given alert cannot be explained, it may be escalated to a yellow alert.

Typically, the crew on the rig knows the reason for the alert, because they are generating the data which gives rise to it. However, in conventional systems, the personnel with the expertise on the rig to dispense with an alert typically do not have access to the data hub due to its proprietary nature. On the other hand, the person monitoring the alerts in the RTC typically does not know the underlying facts giving rise to an alert. Hence, it is common in the operation of an oil rig for the people in the RTC to have to make numerous calls to the rig simply to find out what is happening. Since approximately 90% of all alerts generated on a typical rig are false in the sense that they do not pertain to a real underlying problem, most of these communications from the RTC to the rig are ultimately unnecessary.

On the other hand, the person in the RTC must be able to respond appropriately to alerts when they are real, and hence must have a significant amount of training and experience (typically at least 20 years). Due to the high incidence of spurious alerts, this person spends much of his time calling the rigs under his supervision just to find out what is happening. Consequently, the person in the RTC can typically monitor no more than three rigs at a time (this number is based on best practices in several oil companies today).

By contrast, in the systems described herein, the crew on the rig will preferably have direct access to the data hub 315. Hence, the party responsible for monitoring the mud system will see the alert first and can close it down if it is spurious, because he has access to the system. Hence, the systems described herein may achieve significant reductions in overhead (in terms of manpower), because the frequency at which calls must be placed from the RTC to the rig is significantly reduced. Also, the system may be equipped with an e-mail service 341 and an alarm service 343 which is in communication with a beeper or other means for notifying a party responsible for a system or event with respect to which an alert is being generated so that, when an alert is generated, the person responsible for the area to which it pertains will be notified. The systems described herein allow many problems to be disposed of on the rig, because there are personnel on the rig with expertise to dispose of the problem.

It will be appreciated from the foregoing that the systems disclosed herein allow people associated with a project to collaborate more effectively because they have access to the data hub 315. These systems thus avoid many communications of the type that are necessitated in conventional systems simply by the fact that information is missing or unavailable. In a system 301 of the type depicted in FIG. 3, the person in the RTC may now merely police the alert system and efficiently focus his expertise to provide more value and better service to his customer. Hence, he will still be notified of alerts, but is no longer required to respond in every case.

Referring again to the system of FIG. 3, the service gateway 333 is preferably programmed with open source code, and is adapted to have software installed on it. This feature, denoted as an applications service 345, allows for greater collaboration by experts around the world, because an expert can load his software into the gateway 333, use it to manipulate data in the hub 315, and then share that data and information generated from it with other parties. By contrast, the proprietary systems currently in use do not provide a means by which other parties may readily install their software on a service gateway. Instead, in such systems, it is typically necessary for such parties to have the data transferred to their own computer. Hence, the information these parties produce by processing the data in such systems is an isolated product and isolated work.

By contrast, in the systems described herein, the work product generated by a party may be used by anyone, so long as they have authorization to use the software. Hence, these systems enable “software as a service” (SaaS). For example, these systems allow a software producer to simply charge an end user for using the software, rather than selling the software to the end user outright (that is, the software producer can essentially sell time on the software).

An end user may also be given permission to upload software to the service gateway 333 over the web. By having the SaaS feature, the system 301 allows usable information to be extracted from the data in the data hub 315 without physically moving sensitive data out of the system. This may be particularly useful in applications where movement of data is either not permitted, or is closely regulated. For example, government agencies in countries such as Indonesia do not allow down-hole information to leave the country, making this feature particularly useful in oil and natural gas exploration applications there.

A further advantage of the systems and methodologies disclosed herein relates to their ability to act as an expert geo-location service 351. Since the platform is preferably open by way of a web service 355, anyone working in the industry can register themselves to it. Hence, the platform facilitates the creation of a directory 353 of all of the people that are registered in the system (a “directory of experts”). Preferably, this directory 353 is implemented with the lightweight directory access protocol (LDAP), an application protocol for accessing and maintaining distributed directory information services over an Internet protocol (IP) network.

Currently, oil and gas exploration companies spend significant resources trying to find people with the expertise that they require. However, the systems and methodologies disclosed herein allow anyone to register with the platform and note their areas of expertise, and hence, the platform acts as a marketplace for people wishing to sell their expertise, and provides a means by which the customer may identify potential experts for future work. These experts can also use the applications on the service gateway 333 to look at the customer's data for the purpose of bidding on a job, assessing their fit for a job, or as part of providing a combination of software and their expertise as a service. Currently in the industry, this type of platform does not exist, so collaboration is difficult.

Such collaboration may be further facilitated in the systems and methodologies by the provision of suitable support services. As indicated in the embodiment of FIG. 3, such support services may include voice chat services 361, video conferencing services 363, voice over IP (VOIP) services 365, and the like. A TCP/IP connection 318 and a suitable firewall 334 may be provided to support these services.

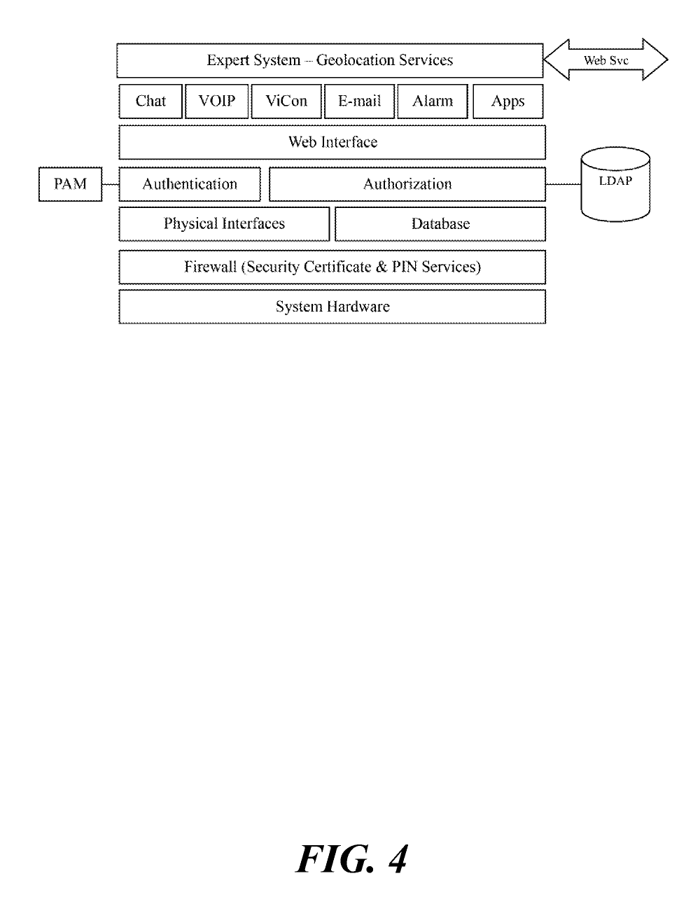

FIG. 4 summarizes the components of both the data hub 315 and the service gateway 333 for the system of FIG. 3. All of these components are preferably web enabled, which means that they can be accessed using a platform independent web browser.

While the systems and methodologies described herein have many advantageous features, two features described herein are especially conducive to the use of some embodiments of the platforms described herein in collaborative efforts. These are (a) a data ownership model in which the user has the capability to control the sharing of data directly or indirectly, and in which a data custodian role is introduced to facilitate this; and (b) a data hierarchy structure that acts as label tag to the user data to help connect a user to the correct target experts, and vice versa.

While the systems and methodologies disclosed herein have been described above primarily in reference to their implementation in oil and natural gas exploration, one skilled in the art will appreciate that these systems and methodologies may be applied in a variety of other fields as well, and are potentially useful in any situation where a real time data stream is available.

For example, these systems and methodologies may be adopted for business or consumer usage in various applications, such as equipment monitoring systems in which the usage of feedstocks (such as, for example, coolant, fluids, fuel or other feedstocks necessary for operation of the equipment) is monitored. In such an application, when supplies of a certain feedstock are running low, the system can make that information available to third parties and can, for example, locate the party willing to supply that feedstock at the lowest price.

As a further example, the systems and methodologies disclosed herein may be adapted to monitor components of an automobile and to notify the owner when maintenance is required. Hence, instead of basing vehicle maintenance on an artificial and inefficient maintenance schedule (such as every 5000 miles), an automobile may be monitored in real time by a control room, and the owner may be notified when service is required. As part of this service, when service is required, an appointment may be set up automatically at a nearby dealership or auto repair shop. Also, the system may make the service information available so that third parties are able to bid on any services that are required. It will be appreciated that this application may find use by individual vehicle users or owners (such as, for example, individual consumers), or by businesses that need to maintain a fleet of vehicles.

Similarly, trucking companies may use the systems and methodologies disclosed herein to monitor the maintenance status and location of their trucks. In these applications, the system may act as a resource and scheduling management system.

The systems and methodologies disclosed herein may also be utilized in retail inventory management, especially for small retailers. This may be achieved, for example, by connecting a black box (data hub) to the cash registers of a retail business. In this way, retail sales transactions may be uploaded on a real time basis to a service gateway on the cloud. This could open up a few possibilities.

For example, retailers may want an inventory control mechanism. A cloud based service gateway of the type described herein may be utilized to manage the inventory for a particular retailer. Such a system may generate an automatic replenishment order to maintain a certain level of inventory based on real time sales information, may adjust prices based on sales trends in real time, and may take other suitable actions to allow the retailers to act on information promptly. Additionally, chain retailers could use the system to make stock information available to consumers in real time, for example, the store location(s) in which a given product is available at that time.

The systems and methodologies described herein may also be utilized to allow retailers to form networks and use their collective bargaining power to get better deals from suppliers. This may allow shops which are individually owned by small shop keepers to combine their purchasing power for the purpose of securing more advantageous terms from suppliers.

The systems and methodologies described herein may also be utilized by merchants to identify suitable experts required to address their business needs. For example, once merchants have their sales and inventory information online, they may be able to seek services from business experts to help them optimize their business models.

Assuming they are willing to share part of their real time sales data, manufacturers and suppliers may leverage the systems and methodologies described herein to obtain sales intelligence in different locations of the world. In particular, manufacturers and suppliers may use such real time sales information for business planning purposes.

The systems and methodologies described herein may also be utilized to perform real time, condition based monitoring in the automotive industry. For example, a user may install data hubs on all vehicles the user wishes to monitor. The data hubs may be used to collect RT data from sensors, and to send this data to a service gateway. On the service gateway, the user may be able to opt to share particular information, or to use an SaaS application to transform the data (for example, such an application may be utilized to transform recorded GPS coordinates to distance traveled and engine hours) and to share this new information with several preferred service providers. Service providers may then monitor the information manually, or may use a SaaS application to generate suitable alarms to provide a quote for services (competitive bidding). The user may then select a service provider based on the quote for services, the proximity of the service provider, and the timing required to procure a maintenance service.

It will be appreciated that the concepts underlying the foregoing example may be readily adapted to other industries as well. These concepts may be applied, for example, to the monitoring used in power plants, mining sites, manufacturing plants and prime movers. Rather than commercial competition, such applications may be directed more toward preventive maintenance and logistics management.

The systems and methodologies described herein may also be applied in the health care industry, and more specifically, in intensive care units (ICUs) in medical centers. In such applications, a black box (data hub) may be utilized to get the real time sensor data from patients in an intensive care unit in a hospital. This data may then be uploaded to a service gateway, where it is accessible by various medical experts. Thus, for example, an expert located on the other side of the world may be able to advise a local medical practitioner based on a real time data feed from the patient.

The systems and methodologies described herein may also be utilized for monitoring the real time production of oil and gas wells. In such an application, a data hub may be installed at the well head of a producing well, and pressure, temperature and flow sensors may be installed on the well head and connected to the data hub. The data hub software may then control the sampling rates of the different well head sensors and accumulate the sensor data in a data base. These sensor data may be uploaded to the data base in the service gateway, where various types of software routines (such as, for example, visualization, production analysis and the like) may be run on the service gateway for optimum production planning and management. Using the same system, sensors may be added to different artificial lift mechanisms, such as rod pumps, gas lifts and electrical submersible pumps. Consequently, condition based maintenance may be carried out for artificial lift equipment in addition to optimizing the performance of the artificial lifts.

The systems and methodologies described herein may also be utilized for coal mine equipment performance management. In such an application, a data hub may be installed on heavy mining mobile equipment, and GPS, fuel level sensors and engine hour sensors may be installed on the equipment and connected to the data hub. The data hub software may then control the sampling rates of the different sensors, and may accumulate the sensor data in a database. This sensor data may then be uploaded to the database in the service gateway, where various software routines (such as equipment location, visualization, scheduling and equipment condition monitoring) may be run on the service gateway for optimum production planning and management. As an added advantage, the monitoring of fuel consumption vs. engine hours may be utilized to prevent fuel pilferage from heavy equipment in remote locations.

The systems and methodologies described herein may also be utilized in procurement operations in the oil and gas industry. In such an application, all operational information available at the service gateway from an oil company's RTO operation may be used to determine the future scope of work for procuring services. Consequently, oil field service providers would be able to participate in the system with real time information concerning service equipment availability and the status of current services. Such an application would thus be able to connect the needs of the oil & natural gas field operators to the availability of a service company's equipment and to the company's service availability. This approach may allow different smaller oil companies with similar needs to be able to pool their needs to leverage the buying power associated with larger volumes. Consequently, service companies may be able to reduce their sales and marketing costs and the costs of missed opportunities by their use of such an application in which oil and natural gas companies will be able to publish their precise service needs.

The systems and methodologies described herein may also be utilized for safety and service quality management in the oil and natural gas industry. In particular, a continuous service quality management system may be established for both the oil and natural gas field operators and the oil field service providers by monitoring drilling rig operations using an RTO system throughout the drilling operation. Such an application could be used to set up an auditable approval system for all mandatory safety and operational tests on a drilling well to ensure compliance with local safety regulations. Once data from real time tests is available on the service gateway, various reports may be generated to aid in managing operational excellence, as well as high safety standards.

The above description of the present invention is illustrative, and is not intended to be limiting. It will thus be appreciated that various additions, substitutions and modifications may be made to the above described embodiments without departing from the scope of the present invention. Accordingly, the scope of the present invention should be construed in reference to the appended claims.

1-23. (canceled)

24. A platform, comprising:
a data hub configured to allow a plurality of users to store data on the data hub and to retrieve data from the data hub;
an interface associated with the data hub which is independently configurable by each of said plurality of users, wherein each user has a set of user preferences associated with that user which controls the configuration of the interface when it is accessed by that user;
a plurality of data files stored on said hub, wherein each of said data files is associated with one of said plurality of users and is accessible via the interface; and
a security system which authenticates a user and which restricts access of the data files to those data files associated with the user.

25. The platform of claim 24, wherein said data hub is programmed with open source code.

26. The platform of claim 24, wherein said platform is disposed at a site containing a real time data source.

27. The platform of claim 24, wherein said interface is a web interface which enables said plurality of users upload data to, and access data from, said data hub.

28. The platform of claim 24, wherein said interface supports video, voice and chat sessions.

29. The platform of claim 24, wherein access of data from said data hub is controlled by an authentication and authorization protocol.

30. The platform of claim 24, further comprising a service gateway, wherein said service gateway allows a user authenticated by the security system to upload software to the service gateway that may be used by the user to produce information from the data stored in the data hub.

31. The platform of claim 30, wherein the uploaded software may be used by parties designated by the user to produce information from the data stored in the data hub.

32. The platform of claim 24, wherein data uploaded to the data hub by a user is tagged with an identifier which identifies the user, and wherein the data hub uses a username and password to restrict access to the uploaded data to parties designated by the user.

33. The data hub of claim 24, wherein said data hub is disposed on an oil or natural gas exploration rig.

34. A non-transitory computer readable medium containing programming instructions, the execution of which, by one or more processors of a computer system, causes the one or more processors to create the platform of claim 24.

35. A method for obtaining services from third parties, comprising:
providing a platform associated with company and upon which third party service providers can register to receive notices of service requests;
posting service requests to the platform, wherein each service request contains a description of the service required; and
receiving bids from the third party service providers in response to the posted service requests.

36. The method of claim 34, wherein the platform comprises (a) a data hub, (b) an interface associated with the data hub which is independently configurable by each of said plurality of users, wherein each user has a set of user preferences associated with that user which controls the configuration of the interface when it is accessed by that user; and (c) a plurality of data files stored on said hub, wherein each of said data files is accessible via the interface.

37. The method of claim 36, wherein each of said data files is associated with one of said plurality of users, and wherein the platform further comprises:
a security system which authenticates a user and which restricts access of the data files to those data files associated with the user.

38. The method of claim 35, wherein said platform is disposed at a site containing a real time data source.

39. The method of claim 36, wherein said interface is a web interface which enables said plurality of users upload data to, and access data from, said data hub.

40. The method of claim 36, wherein access of data from said data hub is controlled by an authentication and authorization protocol.

41. The method of claim 36, wherein data uploaded to the data hub by a user is tagged with an identifier which identifies the user, and wherein the data hub uses a username and password to restrict access to the uploaded data to parties designated by the user.

42. The method of claim 36, wherein the platform further comprises a service gateway, and wherein said service gateway allows a user authenticated by the security system to upload software to the service gateway that may be used by the user to produce information from the data stored in the data hub.

43. The method of claim 42, wherein the uploaded software may be used by parties designated by the user to produce information from the data stored in the data hub.

44. A non-transitory computer readable medium containing programming instructions, the execution of which, by one or more processors of a computer system, causes the one or more processors to carry out the method of claim 35.

45. A method for facilitating collaboration among parties working on a project, data set or data stream, wherein the collaboration involves the generation or manipulation of data by at least one of the parties, the method comprising:
providing a platform comprising (a) a data hub configured to allow a plurality of users to store data on the data hub and to retrieve data from the data hub, (b) an interface associated with the data hub which is independently configurable by each of said plurality of users, wherein each user has a set of user preferences associated with that user which controls the configuration of the interface when it is accessed by that user, (c) a plurality of data files stored on said hub, wherein each of said data files is associated with one of said plurality of users and is accessible via the interface, and (d) a security system which authenticates a user and which restricts access of the data files to those data files associated with the user;
storing the data on the data hub in a plurality of data files;
associating a particular data file with a particular set of users; and
restricting access to each of the plurality of data files to those users associated with the data file.

46. The method of claim 45, further comprising:
allowing a user to manipulate data in the data hub.

47. The method of claim 45, wherein the user manipulates data in the data hub through the use of external software loaded onto a service gateway associated with the hub.

48. A non-transitory computer readable medium containing programming instructions, the execution of which, by one or more processors of a computer system, causes the one or more processors to carry out the method of claim 45.

49. A method by which an entity offers goods or services to other parties, comprising:
providing a platform associated with the entity and upon which parties can register to post requests for goods or services from the entity;
receiving the requests at the platform, wherein each request contains a description of the goods or services required; and
posting bids to the platform from the entity in response to the posted requests.

50. A non-transitory computer readable medium containing programming instructions, the execution of which, by one or more processors of a computer system, causes the one or more processors to carry out the method of claim 49.
